(19) United States
(12) Patent Application Publication
(10) Pub. No.: US 2015/0173381 A1
(43) Pub. Date: Jun. 25, 2015

(54) METHODS AND SYSTEMS FOR APPLYING DECAY INHIBITORS TO POST-HARVEST CROPS IN STORAGE FACILITIES

(71) Applicant: JMC Enterprises, Inc., Kennewick, WA (US)

(72) Inventors: Joel Micka, Kennewick, WA (US); Carlos Arias, Kennewick, WA (US); Michael Lewis, Kennewick, WA (US)

(21) Appl. No.: 14/575,486

(22) Filed: Dec. 18, 2014

Related U.S. Application Data
(60) Provisional application No. 61/918,612, filed on Dec. 19, 2013.

(51) Int. Cl. A23B 7/10

(52) U.S. Cl. CPC A23B 7/10; A23V 2002/00

(57) ABSTRACT

Methods and systems for applying peracetic acid and/or other decay inhibitors to post-harvest crops stored in controlled atmosphere storage facilities are disclosed herein. In one embodiment, a method of applying a decay inhibitor includes forming an aerosol of particles comprising peracetic acid and directing at least a portion of the aerosol into a controlled atmosphere storage facility to provide a substantially uniform distribution of the decay inhibitor over the crops stored therein.

### CROSS-REFERENCE TO RELATED APPLICATION(S)

This application claims the benefit of pending U.S. Provisional Application No. 61/918,612, filed Dec. 19, 2013, which is incorporated herein by reference in its entirety.

### TECHNICAL FIELD

The following disclosure relates generally to methods and systems for applying decay inhibitors to harvested crops, fruits and other foods in storage facilities.

### BRIEF DESCRIPTION OF THE DRAWINGS

FIG. 1 is a partially schematic diagram of decay inhibitor application system at a controlled atmosphere storage facility, configured in accordance with an embodiment of the present disclosure.

FIG. 2 is a flow diagram of a process for preparing and applying a decay inhibitor to post-harvest fruit crops in a storage facility, in accordance with an embodiment of the present disclosure.

FIG. 3 is a flow diagram of a process for preparing and applying a decay inhibitor to post-harvest fruit crops in a storage facility, in accordance with another embodiment of the present disclosure.

### DETAILED DESCRIPTION

The following disclosure describes various embodiments of methods and systems for applying decay inhibitors and/or other chemical substances to post-harvest fruit and/or other crops in storage facilities. In one aspect of the present disclosure, a method of applying a decay inhibitor to post-harvest fruit crops (e.g., pome fruit such as apples, pears, etc.) in a storage facility includes forming an aerosol (e.g., a thermal fog) comprising particles of a decay inhibitor that includes a solution of peracetic acid (also known as peroxyacetic acid or PAA). The method further includes directing at least a portion of the aerosol into the storage facility to provide a substantially uniform distribution of the decay inhibitor over the fruit. In one embodiment, for example, the method further includes determining a characteristic of one or more fruit crops stored in the controlled atmosphere storage facility and adjusting the amount of peracetic acid in the solution based on the determined characteristic. The determined characteristics may include, for example, the cultivar(s), skin conditions, surface moisture, a degree of ripeness, an amount of decay, a temperature, and/or a juice acidity of one or more of the crops.

In another aspect of the present disclosure, a method of applying a decay inhibitor to post-harvest fruit crops (e.g., pome fruit, pit fruits, etc.) stored in a storage facility (e.g., a controlled atmosphere storage facility, a non-controlled atmosphere storage facility, etc.) includes assessing a property of one or more crops stored in the storage facility. The method further includes providing a solution having a concentration of peracetic acid at least partially based on the assessed property. An aerosol (e.g., a thermal fog) comprising particles of the solution can be formed (e.g., using a thermal fogger), and at least a portion of the aerosol can be directed or otherwise released into the controlled atmosphere storage facility, such as to provide a substantially uniform distribution of the solution to the stored crops. The concentration of peracetic acid in the solution can be adjusted, for example, from a first concentration to a second concentration based on the assessed property. In some embodiments, the method includes repeating the assessing, providing, forming and directing at different times. A delay between these times can be, for example, less or equal to about 14 days, between about 14 days and about 30 days, or greater than 30 days.

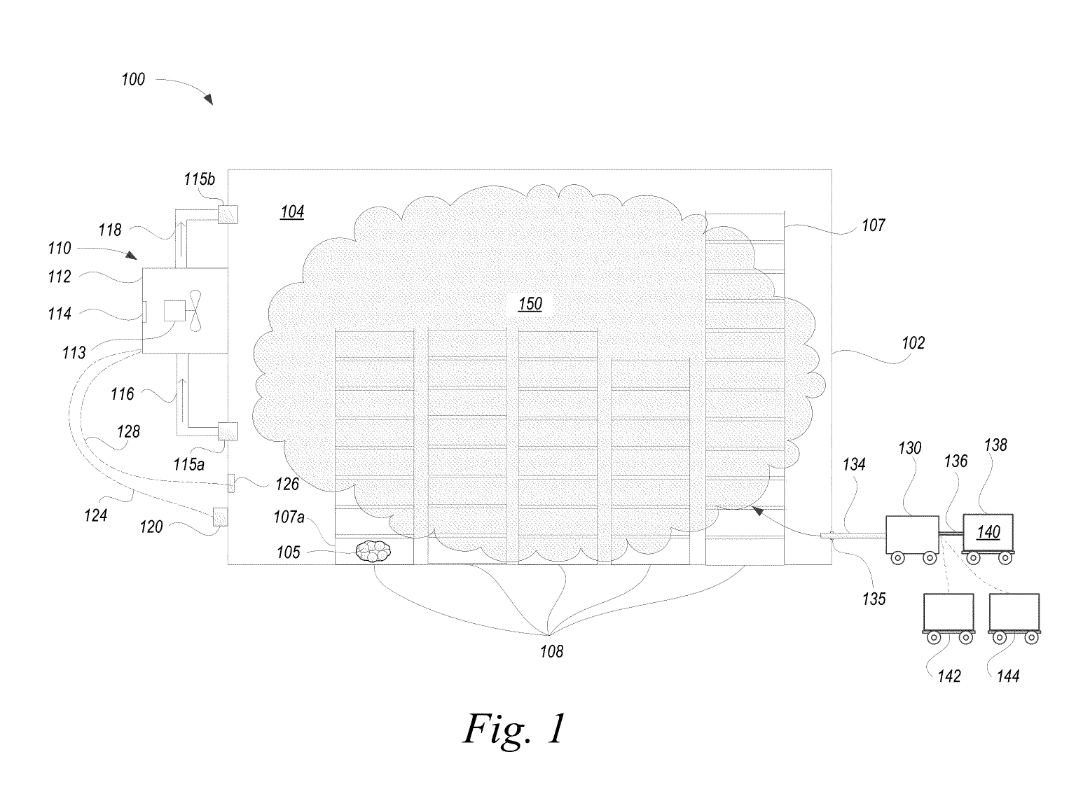

Certain details are set forth in the following description and in FIGS. 1-3 to provide a thorough understanding of various embodiments of the invention. Other details describing well-known methods and systems often associated with the application of decay inhibitors and other substances to post-harvest pome fruits and other fruits, however, are not set forth below to avoid unnecessarily obscuring the description of the various embodiments of the invention.

Many of the details, dimensions, angles and other features shown in the Figures are merely illustrative of particular embodiments of the disclosure. Accordingly, other embodiments can have other details, dimensions, angles and features without departing from the spirit or scope of the present disclosure. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digits or digits of any reference number refer to the Figure in which that element is first introduced. For example, element 112 is first introduced and discussed with reference to FIG. 1.

FIG. 1 is a partially schematic diagram of a storage facility 100 according to several embodiments of the disclosure. The storage facility 100 can be a series of separate structures or a single structure. Furthermore, the storage facility 100 can have virtually any suitable size to meet the needs of a particular farmer or storage company. The storage facility 100 can include a room 102 in which a plurality of crates 107 (including a first crate 107a) are stored. The crates 107 can contain or otherwise hold post-harvest crops 105 (shown, for example, in a partial cutaway view of the first crate 107a). The crops 105 can include, for example, pome fruit (e.g., apples, pears, etc.), other fruit (e.g., cherries, peaches, plums) and/or other crops or products (e.g., onions, potatoes, etc.). In the illustrated embodiment, the crates 107 are arranged in a plurality of stacks 108. In other embodiments, however, the crops 105 can be loosely stored in the storage facility 100 or may be individually packaged.

In one aspect of this embodiment, the crops 105 may be stored for a period of time during which environmental conditions in the storage facility 100 are controlled within predetermined tolerances. The storage facility 100 can include an air control system 110 configured to maintain a controlled atmosphere within the storage facility 100. Maintaining a controlled atmosphere can include, for example, adjusting, monitoring, and/or maintaining oxygen, carbon dioxide, nitrogen, relative humidity, ethylene and/or temperature (e.g., two or more or three or more of these variables) at one or more predetermined levels. The air control system 110 can include an air mover 112 having a fan 113 and an air intake 114. In some embodiments, the fan 113 is a 10-30 horsepower propeller-type ventilation fan having a variable frequency drive that can alter the throughput of the fan 113. In further embodiments (not shown), the air control system 110 can also include one or more heaters (e.g., burners, vane-axial combustion heaters, etc.), one or more coolers (e.g., air conditioning units, chillers, etc.) and/or filters (e.g., carbon filters, lime filters, HEPA filters, etc.). With reference again to FIG. 1, a first conduit or duct 116 (e.g., a round or rectangular duct made of sheet metal) can receive a portion of the air 104 from the room 102 via a room air inlet 115a. The duct 116 can direct the incoming air 104 toward the air mover 112. A second conduit or duct 118 can direct conditioned air from the air mover 112 to the room 102 via the room air outlet 115b.

A controller 120 can be connected to the air mover via a first link 124 (e.g., a wire, a wireless radio connection, etc.) and can be configured to control operations of the air mover 112 and/or other operations of the storage facility 100. In some embodiments, for example, the controller 120 is located remotely and can communicate with the storage facility 100. The controller 120 can be operated, for example, through a remote management system, such as a suitable system disclosed in U.S. Patent Publication No. 2011/0082591, entitled Remote Management of Storage Facilities, which is hereby incorporated by reference herein in its entirety.

A sensor 126 can be disposed in the storage facility 100 and can be connected to the air mover 112 and/or the controller 120 via a second link 128 (e.g., a wire, a wireless radio connection, etc.). The sensor 126 can be configured to gather data such as, for example, a chemical composition of the air 104 (e.g., levels of oxygen, carbon dioxide, nitrogen, ethylene, butyl acetate, methylcyclopropene, ammonia, etc.), temperature, humidity, time, and/or other measurable parameters of the storage facility 100. In the illustrated embodiment, the sensor 126 is shown on an interior wall of the room 102. In other embodiments, however, the sensor 126 may be positioned at any suitable location within room 102 and/or the storage facility 100. Moreover, additional sensors 126 can be employed throughout the storage facility 100.

The air control system 110 can be configured to provide a controlled atmosphere (“CA” hereinafter) environment in the room 102. Providing a CA can comprise adjusting, monitoring, and/or maintaining oxygen, carbon dioxide, nitrogen, relative humidity, and/or temperature in the air 104 at one or more predetermined levels. The composition of ambient air at standard temperature and pressure is approximately 78% nitrogen, 21% oxygen, 0.04% carbon dioxide and small amounts of other gases. Providing a CA environment can include, for example, increasing or decreasing the levels of one or more air constituents. In some CA environments, for example, concentrations of oxygen are reduced to 10% or less by volume of the air 104 (e.g., to less than 2% oxygen). A reduction in oxygen can be performed, for example, by adding a corresponding amount of nitrogen to the air 104. Moreover, in some CA environments, a concentration of carbon dioxide in the air 104 may be increased, such as, to 0.5% or greater of the air 104 (e.g., 1% carbon dioxide, 2% carbon dioxide, etc.). Removing oxygen from and adding carbon dioxide to the air 104 can increase an amount of time that the crops 105 (e.g., post-harvest fruits) can be stored in the storage facility 100 without significant loss of quality.

As those of ordinary skill in the art will appreciate, however, post-harvest crops in CA conditions can still be affected by spoilage and/or decay caused by, for example, bacteria, fungi, other microorganisms and/or other sources of decay. A single dose and/or occasional doses of a decay inhibitor (e.g., peracetic acid) can be delivered to post-harvest crops (apples, pears, and/or other fruits) in CA environments to reduce sources of decay and prolong an amount of time that the crops can be maintained above a threshold. Conventional decay inhibitor delivery systems (cold foggers, sprayers, misters, hazers, etc.) may not suitable for use in CA environments for at least the reason that conventional delivery systems may produce aerosols that are not capable of delivering decay inhibitor to crops stored in crates or other compact arrangements typical of CA environments. Sprays, mists and cold fogs, for example, at least typically include particles greater than 20 microns that have limited persistence and/or inconsistent distribution in a gaseous environment. The disclosed technology is expected to facilitate a substantially uniform distribution of decay inhibitor to post-harvest crops in CA environments. These systems and methods may be safer and faster than conventional methods while also conforming, at least in some cases, to organic food certifications (e.g., USDA Organic Certification).

Referring again to FIG. 1, an aerosol-generating device 130 (e.g., a thermal fogger) can be positioned proximate the room 102. A container 138 configured to hold a solution 140 (e.g., a decay inhibitor, a decay inhibitor solution comprising peracetic acid (also known as peroxyacetic acid or PAA) can be coupled to the aerosol-generating device 130 via a first conduit 136. A second conduit 134 can be inserted through a receptacle 135 (e.g., a porthole having an operable door) and to operably couple the aerosol-generating device 130 to the room 102. In some embodiments, the aerosol-generating device 130 comprises an electric device that receives power from an electric generator (not shown). In other embodiments, however, the aerosol-generating device 130 can utilize a non-electric power source. For example, the aerosol-generating device 130 can be a combustion-based device that operates on gasoline, propane, and/or other combustible fuels.

During application, the aerosol-generating device 130 can draw the solution 140 from the container 138 via the first conduit 136. The aerosol-generating device 130 can then generate an aerosol 150 (e.g., a thermal fog) from the solution 140. The aerosol 150 can pass through the second conduit 134 into the room 102 and provide a substantially uniform distribution of the solution 140 to the crops 105 stored in the room 102. In some embodiments, the aerosol 150 comprises particles having a diameter less than 20 microns (e.g., between about 1.0 micron and about 10 microns, between about 10 microns and about 20 microns, etc.) In other embodiments, however, the aerosol 150 may comprise particles with any suitable diameter.

In some embodiments, the aerosol-generating device 130 can be configured to modify, adjust or otherwise alter the relative amounts by volume of individual constituents in the solution 140. As shown in the illustrated embodiment of FIG. 1, the aerosol-generating device 130 can be coupled to containers 142 and 144. The containers 142 and 144 can be configured to store individual constituents of the solution 140. The container 142 can store, for example, a first constituent (e.g., a decay inhibitor, peracetic acid, etc.), and the container 144 can store, for example, a second constituent (e.g., hydrogen peroxide, a solvent, etc.) or an additional quantity of the solution 140. In one embodiment, for example, the solution 140 comprises approximately 5% by volume peracetic acid, and approximately 25-30% by volume hydrogen peroxide with one or more inactive ingredients (e.g., water) may comprise the remaining percentage by volume of the solution 140. In other embodiments, however, the solution 140 may comprise up to 20% by volume of peracetic acid (e.g., between about 0.2% by volume and about 16% by volume of peracetic acid, between about 4% by volume and about 12% by volume of peracetic acid, etc.). In further embodiments, the solution 140 can comprise any suitable concentration of peracetic acid (e.g., between about 0.2% by volume and about 90% by volume).

The aerosol-generating device 130 can be configured, for example, to adjust the solution 140 in response to, for example, an evaluation of the condition of the crops 105. For example, if one or more crops 105 is determined to have a blemishes (e.g., weakened skin as the result of decay, a weather event prior to harvest, etc.) the amount of a decay inhibitor (e.g., peracetic acid) in the solution 140 can be correspondingly adjusted. Accordingly, the relative potency or intensity of the decay inhibitor in the solution 140 and, thus, the aerosol 150 can be increased or decreased based on the condition or characteristics of the crops 105 stored in the room 102.

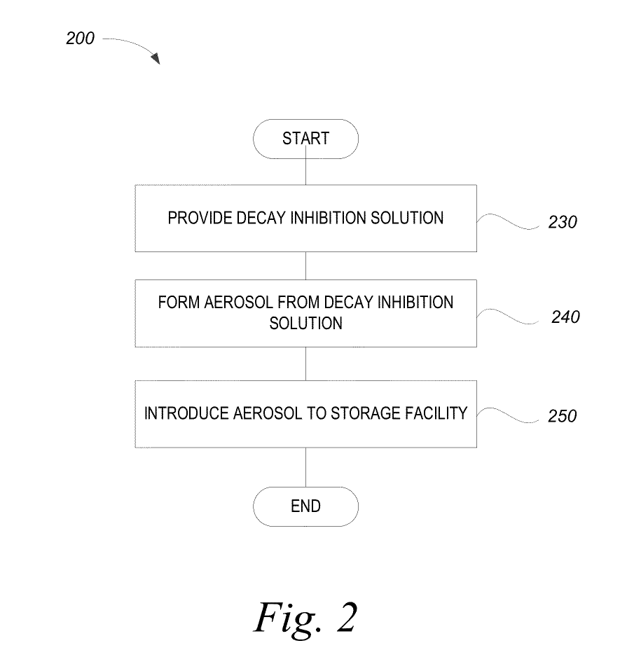

FIG. 2 is a flow diagram of a process 200 for preparing and applying a decay inhibitor to post-harvest crops in a storage facility, in accordance with an embodiment of the present disclosure. Various portions of the process 200 can be carried out by an aerosol-generating device (e.g., the aerosol-generating device 130 of FIG. 1). In block 230, a decay inhibition solution (e.g., the solution 140 of FIG. 1) is provided at a CA storage facility (e.g., the storage facility 100 of FIG. 1). The decay inhibition solution can include any suitable decay inhibitor such as, for example, peracetic acid. In one embodiment, the decay inhibition solution includes, among other ingredients (e.g., water) approximately 5% peracetic acid by volume and approximately 27% hydrogen peroxide by volume. In other embodiments, the decay inhibition solution may include between about 0.2% peracetic acid by volume and about 20% peracetic acid by volume. In block 240, the aerosol-generating device forms an aerosol (e.g., a thermal fog) from the decay inhibition solution. In some embodiments, the aerosol can include particles having diameters between about 1.0 micron and about 10 microns. In other embodiments, the aerosol can include particles having diameters less than 1.0 micron or greater than 10 microns.

In block 250, the aerosol is introduced to the controlled atmosphere storage facility. The aerosol, for example, can travel from the aerosol generating device to a CA storage facility holding post-harvest crops (e.g., pome fruit) and provide a substantially uniform distribution of the decay inhibition to the outer surfaces of at least a portion of the crops (e.g., at least 50% of the exposed outer surfaces). Moreover, as noted above in reference to FIG. 1, CA storage facilities are typically configured to provide an environment having oxygen levels of 10% or less by volume. As those of ordinary skill art will appreciate, spaces or environments having extremely low oxygen levels (e.g., less than 10%) can be dangerous for nearby persons (e.g., an operator of the aerosol generating device). Therefore, in some embodiments, block 250 also comprises adjusting oxygen levels in the CA storage facility to suitable levels (e.g., approximately 21% by volume of air in the storage facility). After block 250, the process 200 ends.

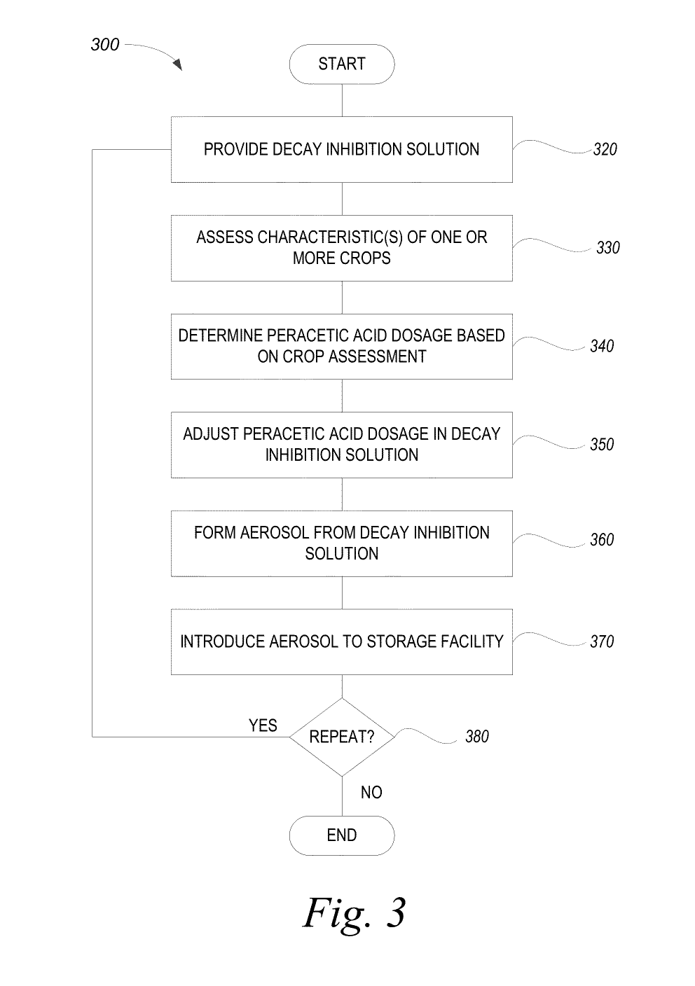

FIG. 3 is a flow diagram of a process 300 for preparing and applying a decay inhibitor to post-harvest crops in a storage facility, in accordance with another embodiment of the present disclosure. As in the process 200 described above, various portions of the process 200 can be carried out by an aerosol-generating device. In block 320, a decay inhibition solution having peracetic acid is provided at a CA storage facility (e.g., the storage facility 100 of FIG. 1). In one embodiment, for example, the decay inhibition solution may include between about 0.2% peracetic acid by volume and about 20% peracetic acid by volume.

In block 330, characteristics, properties or conditions of the one or more crops stored in the CA storage facility are assessed or evaluated. Characteristics may include, for example, the cultivar(s), skin conditions, surface moisture, a degree of ripeness, an amount of decay, a temperature, a juice acidity of one or more of the crops and/or an accumulated storage time. The assessment of the characteristics may include inspection of one or more of the crops to determine skin conditions (e.g., a presence of sunburn, pitting, scalding, blemishes, etc., on an exterior surface of one or more of the crops), ripeness and/or decay (e.g., decay caused by microorganisms, bacteria, mold, yeast, fungi, etc.). The assessment of the characteristics may also include, for example, a temperature, external moisture, juice acidity, etc. of one or more of the crops. Some other quantities (e.g., cultivar(s), accumulated storage time, etc.) may be predetermined.

In block 340, an appropriate amount or dosage of peracetic acid can be determined based on the assessment of one or more of the characteristics in block 330. In one embodiment, for example, a concentration of peracetic acid in the decay inhibition solution is adjusted (e.g., increased) based on an amount of decay detected on one or more of the crops. In another embodiment, for example, a concentration of peracetic acid in the decay inhibition solution may be adjusted (e.g., increased or decreased) based on the cultivar (e.g., red delicious apples, Fuji apples, Braeburn apples, and/or other apple cultivars) of the crops stored in the CA facility. In block 350, the decay inhibition solution may be modified (e.g., a concentration of peracetic acid is decreased, a concentration of peracetic acid is increased, etc.) until the solution has approximately the amount of peracetic acid determined in block 340. In some embodiments, however, the decay inhibition solution provided in block 320 may already have the determined level of peracetic acid, in which case the process 300 proceeds to block 360.

In block 360, the aerosol-generating device forms an aerosol (e.g., a thermal fog) from the decay inhibition solution. In block 370, the aerosol is introduced to the CA storage facility and provides a substantially uniform distribution of the decay inhibition solution to the crops stored therein. In the block 380, an operator determines whether to perform an additional application of the decay inhibitor solution. If not, the process 300 ends. If the operator, however, determines that an additional application of the decay inhibitor is necessary, the process 300 returns to block 320. In some embodiments, for example, the operator may pause for a predetermined period of elapsed time (e.g., 1 hour, 1 day, between about 1 day and about 14 days, between about 14 days and about 30 days, and/or another suitable time between applications of the decay inhibitor). After pausing, the process 300 proceeds to block 320 for an additional application of the decay inhibitor.

From the foregoing, it will be appreciated that specific embodiments of the invention have been described herein for purposes of illustration, but that various modifications may be made without deviating from the spirit and scope of the various embodiments of the invention. For example, while much of the discussion above has focused on the use of peracetic acid with pome fruits, the methods and systems described herein can also be used to apply peracetic acid and/or other types of decay inhibitors to other fruits and/or other types of post-harvest crops. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A method for inhibiting decay of post-harvest pome fruits stored in a controlled atmosphere storage facility, the method comprising:
forming an aerosol including particles of a solution comprising a concentration of peracetic acid between about 0.2% and about 90% by volume; and
releasing at least a portion of the aerosol into a controlled atmosphere storage facility containing post-harvest pome fruits.

2. The method of claim 1, further comprising:
determining a characteristic of one or more of the fruits; and
adjusting the concentration of peracetic acid in the solution based on the determined characteristic.

3. The method of claim 1 wherein forming an aerosol comprises forming a thermal fog.

4. The method of claim 1 wherein forming an aerosol comprises forming an aerosol comprising particles having a diameter of about 10 microns or less.

5. The method of claim 1 wherein the releasing comprises providing a substantially uniform distribution of the decay inhibitor to the fruits.

6. A method for inhibiting decay of post-harvest fruits stored in a controlled atmosphere storage facility, the method comprising:
assessing a property of post-harvest fruits stored in a controlled atmosphere storage facility;
forming an aerosol comprising particles of a solution having a concentration of a decay inhibitor, wherein the concentration is selected at least partially based on the assessed property; and
releasing at least a portion of the aerosol into the controlled atmosphere storage facility to provide a substantially uniform distribution of the solution to the fruits.

7. The method of claim 6 wherein the decay inhibitor comprises peracetic acid, and wherein the concentration is between about 0.2% and about 90%.

8. The method of claim 6 wherein forming an aerosol comprises adjusting the concentration of the decay inhibitor in the solution from a first concentration to a second concentration based on the assessed property of the fruits.

9. The method of claim 6 wherein forming an aerosol comprises forming a thermal fog.

10. The method of claim 6 wherein releasing at least a portion of the aerosol includes releasing at least a portion of the aerosol at a first time, the method further comprising:
repeating the assessing, forming and releasing a second time after a predetermined delay.

11. The method of claim 10 wherein the predetermined delay is between about 1 day and about 14 days.

12. The method of claim 10 wherein the predetermined delay is between about 14 days and about 30 days.

13. The method of claim 6 wherein the assessing comprises assessing a skin condition of one or more of the fruits.

14. The method of claim 6 wherein the fruits comprise apples or pears.

15. The method of claim 6 wherein the fruits comprise pit fruits.
